(19) United States
(12) Patent Application Publication
(10) Pub. No.: US 2025/0229611 A1
(43) Pub. Date: Jul. 17, 2025

(54) TONNEAU COVER FOR PICKUP TRUCK

(71) Applicant: Yunxia SHAO, HANGZHOU (CN)

(72) Inventors: Shaoyong ZHENG, HANGZHOU (CN); Yunxia SHAO, HANGZHOU (CN)

(21) Appl. No.: 19/014,051

(22) Filed: Jan. 8, 2025

(30) Foreign Application Priority Data
Jan. 11, 2024 (CN) 202420075168.8

(51) Int. Cl. B60J 7/14; B60J 7/00

(52) U.S. Cl. CPC B60J 7/141; B60J 7/0084

(57) ABSTRACT

This invention discloses a tonneau cover for pickup truck, including a rail system, hinge system, cover panel, and clip system. The rail system is connected to the truck bed via the clip system. The cover panel is connected to the rail system and includes multiple panels, which are connected to each other through the hinge system. This invention employs a hinge system to enable relative rotation between panels, and it incorporates compensating rubber strips on the hinge system. The squeezing seal between the compensating rubber and hinge strips enhances the waterproofing at the rotation points, addressing issues of water leakage in the truck cover.

### CROSS-REFERENCES TO RELATED APPLICATIONS

The present disclosure claims the priority of Chinese Patent Application No. 202420075168.8, filed on Jan. 11, 2024, the entireties of which are herein incorporated by reference.

### FIELD

This invention pertains to the field of automotive accessories, specifically to a tonneau cover for pickup truck.

### BACKGROUND

Pickup trucks are a common type of vehicle in daily life. Known for their comfort, stability, and cargo transportation capabilities, they are an indispensable part of the automotive market. The truck bed, as the most distinctive feature of a pickup truck, is often used for transporting goods.

Existing pickup trucks are increasingly being equipped with covers to facilitate use in rainy and snowy weather. These covers are generally divided into soft covers and hard covers. Soft covers use waterproof fabric to block rain, whereas hard covers use panels to form a cover that blocks rain. Compared to soft covers, hard covers have a certain strength but feature more complex connection structures. Existing covers often have inadequate sealing at the joints, which can lead to leakage problems.

### SUMMARY

To overcome the deficiencies of the existing technology, the objective of this invention is to provide a tonneau cover for pickup truck that improves the waterproof effectiveness through the rotating structure of the cover panel, addressing the aforementioned issues.

To solve the problems present in the existing technology, the technical solution adopted by this invention is:

A tonneau cover for pickup truck, including a rail system, a hinge system, cover panels, and a clip system.

The rail system is connected to the truck bed through the clip system.

The cover panel is connected to the rail system and includes multiple panels, which are interconnected via the hinge system.

The hinge system includes a first hinge and a second hinge. The first hinge comprises a first pivot rod, a second pivot rod, a rotating hinge, hinge rubber strips, compensating rubber strips, a first joint, and a second joint. The first pivot rod and the second pivot rod are connected by the rotating hinge. Sides of the first and second pivot rods that are close to each other are each fitted with hinge rubber strips. The ends of the first pivot rod are connected to the first joint, and the ends of the second pivot rod are connected to the second joint. The first joint and the second joint are connected by compensating rubber strips, which are equipped with extrusion protrusions. These protrusions are designed to compress against the hinge rubber strips to create a seal.

By employing a hinge system that enables relative rotation between panels and adding compensating rubber strips to the hinge system, the seal created by the compression of the compensating rubber strips against the hinge rubber strips enhances the waterproofing at the joints, thereby resolving issues of water leakage in the truck cover.

Furthermore, the hinge system also includes a third hinge, which comprises a central shaft for the third hinge. The second hinge includes a central shaft for the second hinge, and the widths of the central shafts for the second and third hinges are the same.

The second and third hinges can use the same structure or different structures. Using the same structure and dimensions allows for production using a single set of molds, saving manufacturing costs and improving production efficiency.

Furthermore, the panel includes large, medium, and small panels. The large panel is equipped with a first slot and a second slot. The first slot has a first hook and a third hook connected at its ends, while the second slot has a second hook and a fourth hook connected at its ends. The first hook, second hook, third hook, and fourth hook are all used to engage the rail system. The panel can be any one of the large, medium, or small panels, selected based on the size of the truck cover and customer preferences. The large panel can have two slots with hooks connected at the ends of each slot. Using hooks to latch onto the rail system ensures a stable connection of the panel. This four-point connection structure provides stable support, or a single slot can be used to reduce production costs, although it offers less stability in the connection. The hooks mentioned here are existing technology, and existing hooks can be directly utilized. The main innovative aspect lies in the four hooks providing four-point positioning.

Furthermore, the panel includes large, medium, and small panels. The large panel is equipped with a first slot, a second hook, a second slot, a fourth hook, and a locking tongue system. The large panel features a first slot and a second large panel slot, with the first slot connected to the locking tongue system. Each end of the second slot is connected to the second hook and the fourth hook, similarly featuring two slots. One slot connects to two hooks, and the other slot connects to the locking tongue system. The locking tongue system includes two elastic latches connected by a steel wire. Pulling the steel wire causes both elastic latches to retract simultaneously, facilitating the opening of the large panel. The locking tongue system makes opening and closing more convenient, but its production cost is higher compared to using two hooks.

Furthermore, the rail system includes a head seal block, a first front rubber strip, a water guide block, an outlet pipe, a rail, and a second front rubber strip. One end of the rail is connected to the head seal block, and the other end has a rail notch, to which the water guide block is connected. The water guide block is connected to the outlet pipe. Both the first and second front rubber strips are attached to the rail. The head seal block, first front rubber strip, and water guide block form a U-shaped waterproof barrier, while the second front rubber strip forms a second waterproof barrier. The water guide block is equipped with limit protrusions and a water-blocking protrusion; the limit protrusion abuts the rail notch for positioning, and the water-blocking protrusion serves to restrict the flow of water. The rail is mounted on both sides of the truck bed and is used to connect the cover panel. The second front rubber strip is mounted on the rail, causing rainwater to drain to the outside of the truck bed under its influence, preventing water from entering the rail. The first front rubber strip further separates the interior of the cargo area from the exterior; any infiltrating rainwater is blocked by the first front rubber strip, entering the U-shaped channel formed between the rail and the first front rubber strip. With the head seal block and water guide block at either end of the rail, the head seal block acts as a seal while the water guide block, connected to the outlet pipe, facilitates drainage. The water inlet of the water guide block is located at its upper end, allowing water to flow into the block under gravity and be expelled automatically.

Furthermore, the clip system includes a left clip, a right clip, a threaded block, a T-bar, and a star nut. The left clip and right clip are used to clamp the truck bed and the rail. The left and right clips are connected by a screw, with one end of the screw attached to the threaded block, which is locked into the right clip. The T-bar passes through the left and right clips, with one end of the T-bar abutting the left clip and the other end connected to the star nut. The left clip extends into the rail groove, while the right clip clamps the truck bed from the outside, securing the rail to the vehicle body. The threaded block is then attached to the right clip, locking into place. The screw passes through the left clip and threads into the threaded block, achieving horizontal clamping between the left and right clips in one step. Finally, the T-bar is connected to the star nut, and by tightening the nut, the left and right clips are drawn together vertically, enabling multidirectional fastening of the clip system.

Furthermore, the hinge rubber strips include a first hinge rubber strip and a second hinge rubber strip. The first hinge rubber strip is attached to the first pivot rod, and the second hinge rubber strip is attached to the second pivot rod. The first hinge rubber strip features a first compression surface, while the second hinge rubber strip features a second compression surface. The first and second hinge rubber strips are positioned on either side of the compensating rubber strip. The first and second compression surfaces, together with the extrusion protrusions, form pressurized surfaces. Both the first and second joints are equipped with a first adhesive surface and a second adhesive surface. The compensating rubber strip is also equipped with a first adhesive surface and a second adhesive surface, which adhere to the first and second adhesive surfaces of the joints, respectively. Since gaps can form between the pivot rods during rotation within the hinge system, hinge rubber strips are placed between the two pivot rods. The central area is sealed by the mutual compression of the two hinge rubber strips, while compensating rubber strips are added at the ends. The compression interaction between the compensating rubber strips and the hinge rubber strips enhances the waterproofing. Joints are connected to both ends of the pivot rods to integrate with the rail structure, and the joints are adhered to the compensating rubber strips, ensuring stable connections while improving waterproof performance.

Furthermore, the first joint is also equipped with a profile cover, a first screw hole, a rubber strip insertion slot, a screw arch, and a second screw hole. The profile cover is used to connect the panel, while the joint protrusion is used to connect the rail. The rubber strip insertion slot connects the hinge rubber strip, and the screw arch and second screw hole are used to connect the joint to the pivot rod. The joint is secured to the pivot rod with screws, ensuring connection stability and preventing water leakage. Additionally, the profile cover connects to the profiles at both ends of the panel. Finally, the first joint connects to the hinge rubber strip through the rubber strip insertion slot, allowing the hinge rubber strip to pass through the pivot rod and the joint, enhancing overall integrity and improving sealing performance.

Furthermore, the second hinge includes a second hinge central shaft, a side rod, a third hinge rubber strip, and a side rod wire. The third hinge rubber strip comprises a rubber strip insertion head and a rubber strip adhesive surface. The side rod is equipped with a side rod rubber strip insertion slot and a side rod adhesive surface. The rubber strip insertion head connects to the side rod rubber strip insertion slot, while the side rod wire extends into the side rod rubber strip insertion slot and compresses the rubber strip insertion head. The rubber strip adhesive surface adheres to the side rod adhesive surface. Unlike the first hinge, the second hinge features a central rod with a side rod on each side for connecting the panel. The rotation center between the side rod and central rod is equipped with a third hinge rubber strip for waterproofing. The third hinge rubber strip is clamped between the central rod and connecting section. The side rod wire is inserted into the side rod rubber strip insertion slot, compressing the rubber strip insertion head to ensure fuller filling of the rubber strip, thus enhancing the sealing performance.

The beneficial effects of this invention are as follows:
1. By employing a hinge system that allows relative rotation between panels and incorporating compensating rubber strips in the hinge system, this invention improves the waterproofing at the rotation points through the compressive seal between the compensating and hinge rubber strips, thereby resolving the issue of water leakage in the truck cover.
2. This invention improves sealing performance by using rubber strips and steel wires to tightly seal the pivot system.
3. By optimizing the rail system, this invention ensures more efficient drainage, thereby preventing water leakage.

### BRIEF DESCRIPTION OF THE DRAWINGS

FIG. 1: First structural schematic of the invention.

FIG. 2: Second structural schematic of the invention.

FIG. 3: Third structural schematic of the invention.

FIG. 4: Fourth structural schematic of the invention.

FIG. 5: Structural schematic of the rail system in the invention.

FIG. 6: Enlarged view of part A in FIG. 5.

FIG. 7: Structural schematic of the water guide block in the invention.

FIG. 8: Fifth structural schematic of the invention.

FIG. 9: Enlarged view of part B in FIG. 8.

FIG. 10: Structural schematic of the first hinge.

FIG. 11: Enlarged view of part C in FIG. 10.

FIG. 12: Enlarged view of part D in FIG. 10.

FIG. 13: Connection schematic of the joint.

FIG. 14: First structural schematic of the joint.

FIG. 15: Second structural schematic of the joint.

FIG. 16: Third structural schematic of the joint.

FIG. 17: Structural schematic of the compensating rubber strip.

FIG. 18: Structural schematic of the second hinge.

FIG. 19: Enlarged view of part E in FIG. 18.

1—First hinge; 11—First pivot rod; 12—Second pivot rod; 13—Rotating hinge; 14—First hinge rubber strip; 1401—First compression surface; 15—Second hinge rubber strip; 1501—Second compression surface; 16—Compensating rubber strip; 1601—Extrusion protrusion; 1602—First adhesive surface; 1603—Second adhesive surface; 17—First joint; 1701—First adhesive surface; 1702—Second adhesive surface; 1703—Joint protrusion; 1704—First screw hole; 1705—Profile cover; 1706—Rubber strip insertion slot; 1707—Screw arch; 1708—Second screw hole; 18—Second joint; 2—Second hinge; 21—Second hinge central shaft; 22—Side rod; 2201—Side rod rubber strip insertion slot; 2202—Side rod adhesive surface; 23—Third hinge rubber strip; 2301—Rubber strip insertion head; 2302—Rubber strip adhesive surface; 24—Side rod wire; 3—Rail system; 31—Head seal block; 32—First front rubber strip; 33—Water guide block; 3301—Limit protrusion; 3302—Water inlet; 3303—Water-blocking protrusion; 3304—Water outlet; 34—Outlet pipe; 35—Rail; 3501—Rail notch; 36—Second front rubber strip; 4—Large panel; 41—First slot; 42—First hook; 43—Second hook; 44—Second slot; 45—Third hook; 46—Fourth hook; 47—Locking tongue system; 5—Clip system; 51—Left clip; 52—Right clip; 53—Threaded block; 54—T-bar; 55—Star nut; 6—Third hinge; 61—Third hinge central shaft.

### DETAILED DESCRIPTION OF THE DISCLOSURE

Below, the invention is further elaborated in conjunction with the accompanying drawings and their corresponding reference numbers.

To more clearly understand the objectives, features, and advantages of this invention, the following detailed description is provided with reference to the accompanying drawings and specific embodiments. It should be noted that, where there is no conflict, the features of the embodiments in this application may be combined.

The terms “first,” “second,” “third,” etc., are used solely for descriptive purposes and should not be interpreted as indicating or implying relative importance.

In the description of this invention, it should also be noted that unless otherwise explicitly defined or limited, terms such as “set,” “install,” “connect,” and “link” should be interpreted broadly. For example, they may refer to fixed connections, detachable connections, or integrated connections; they may involve mechanical or electrical connections; they may refer to direct connections or indirect connections via an intermediary; and they may also refer to internal communication between two components. For those skilled in the art, the specific meanings of these terms in this invention can be understood based on the context.

The specific embodiments of this invention are detailed below in conjunction with the accompanying drawings. It should be understood that the specific embodiments described here are provided solely for illustration and explanation and are not intended to limit the invention.

### Embodiment 1

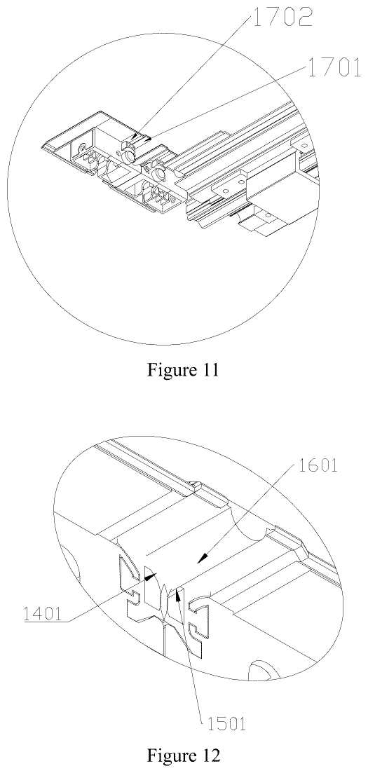

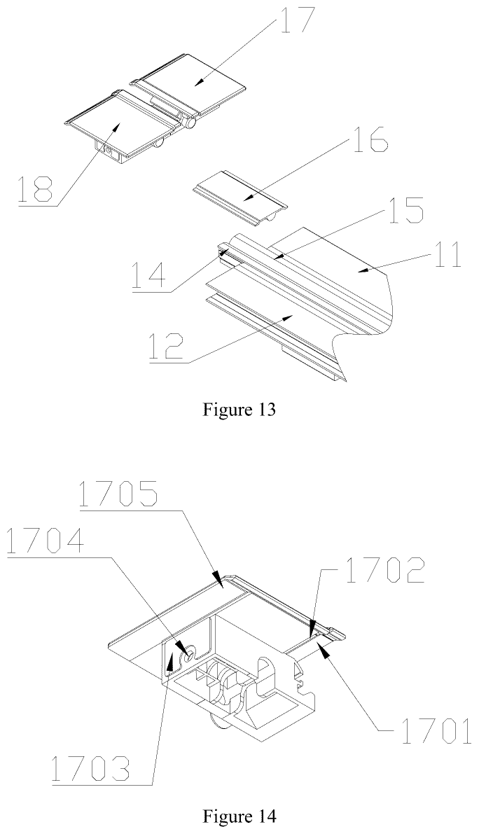

As shown in FIGS. 1 and 10-13, the tonneau cover for pickup truck includes a rail system 3, a hinge system, a cover panel, and a clip system 5.

The rail system 3 is connected to the truck bed through the clip system 5.

The cover panel is connected to the rail system 3 and consists of multiple panels. The panels are interconnected through the hinge system.

The hinge system includes a first hinge 1 and a second hinge 2. The first hinge 1 comprises a first pivot rod 11, a second pivot rod 12, a rotating hinge 13, hinge rubber strips, compensating rubber strips 16, a first joint 17, and a second joint 18. The first pivot rod 11 and the second pivot rod 12 are connected by the rotating hinge 13. Both sides of the first pivot rods 11 and second pivot rods 12 that are close to each other are fitted with hinge rubber strips. The ends of the first pivot rod 11 are connected to the first joint 17, and the ends of the second pivot rod 12 are connected to the second joint 18. The first joint 17 and second joint 18 are connected by compensating rubber strips 16, which feature extrusion protrusions 1601. These extrusion protrusions 1601 are designed to compress against the hinge rubber strips, creating a secure seal.

By employing the hinge system, relative rotation between panels is achieved, and compensating rubber strips 16 are added to the hinge system. The compressive seal formed between the compensating rubber strips 16 and the hinge rubber strips enhances the waterproofing at the rotation points, addressing the issue of water leakage in the truck cover.

### Embodiment 2

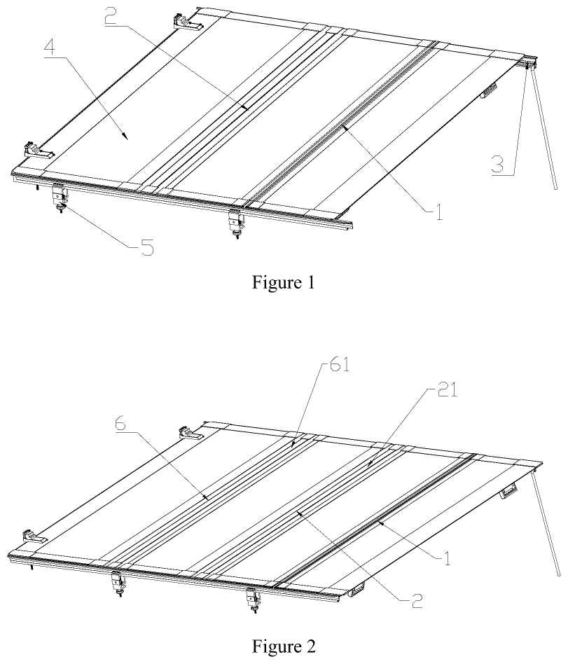

Based on Embodiment 1, as shown in FIG. 2, the hinge system further includes a third hinge 6. The third hinge 6 comprises a third hinge central shaft 61, while the second hinge 2 includes a second hinge central shaft 21. The second and third hinge central shafts 61 have the same width.

The second hinge 2 and the third hinge 6 can use either the same structure or different structures. Using the same structure and dimensions allows production with a single mold, reducing manufacturing costs and improving production efficiency.

### Embodiment 3

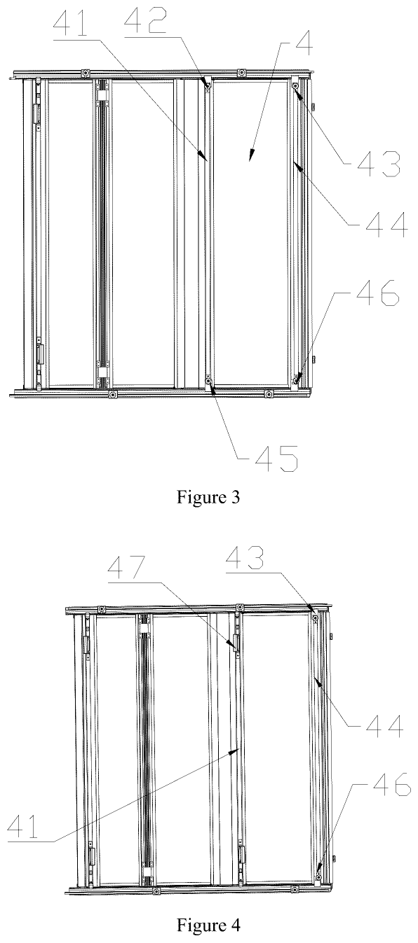

Based on Embodiment 1, as shown in FIG. 3, the panel includes a large panel 4, a medium panel, and a small panel. The large panel 4 is equipped with a first slot 41 and a second slot 44. The first slot 41 has a first hook 42 and a third hook 45 connected at its ends, while the second slot 44 has a second hook 43 and a fourth hook 46 connected at its ends. The first hook 42, second hook 43, third hook 45, and fourth hook 46 are all used to engage the rail system 3.

The panel can be any one of the large panel 4, medium panel, or small panel, depending on the size of the truck cover and customer preferences. The large panel 4 may have two slots with hooks at both ends of each slot. The hooks secure the rail system 3, ensuring a stable connection of the panel. This four-point connection structure provides stable support, although using a single slot could reduce production costs at the expense of connection stability. The hooks described here are existing technology and can be used directly. The main innovation lies in the four hooks providing four-point positioning.

### Embodiment 4

Based on Embodiment 2, as shown in FIG. 4, the panel includes a large panel 4, a medium panel, and a small panel. The large panel 4 is equipped with a first slot 41, a second hook 43, a second slot 44, a fourth hook 46, and a locking tongue system 47. The large panel 4 features a first slot 41 and a second slot for the large panel 4. The first slot 41 is connected to the locking tongue system 47, and both ends of the second slot 44 are connected to the second hook 43 and the fourth hook 46.

Similarly, two slots are set up: one slot connects to two hooks, and the other connects to the locking tongue system 47 the locking tongue system 47 being existing technology. The locking tongue system 47 includes two elastic latches connected by a steel wire. Pulling the steel wire causes both elastic latches to retract simultaneously, facilitating the opening of the large panel 4. The locking tongue system 47 makes opening and closing more convenient, though its production cost is higher than that of using two hooks.

### Embodiment 5

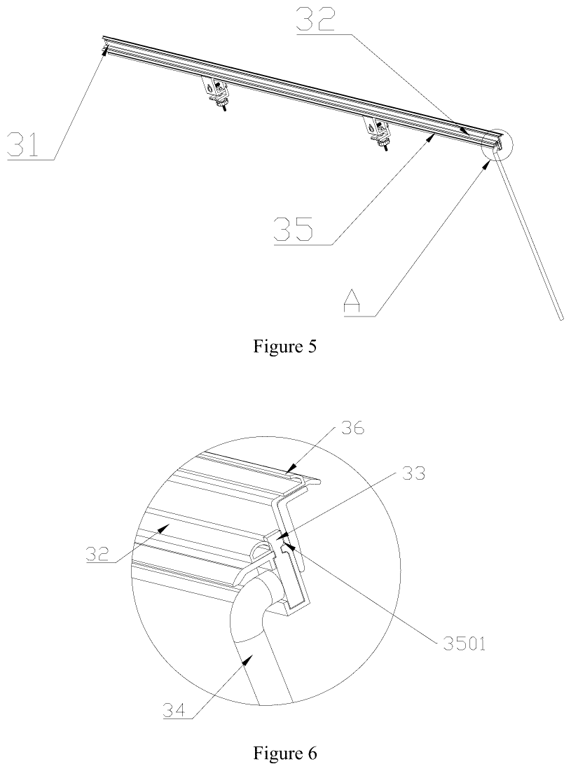

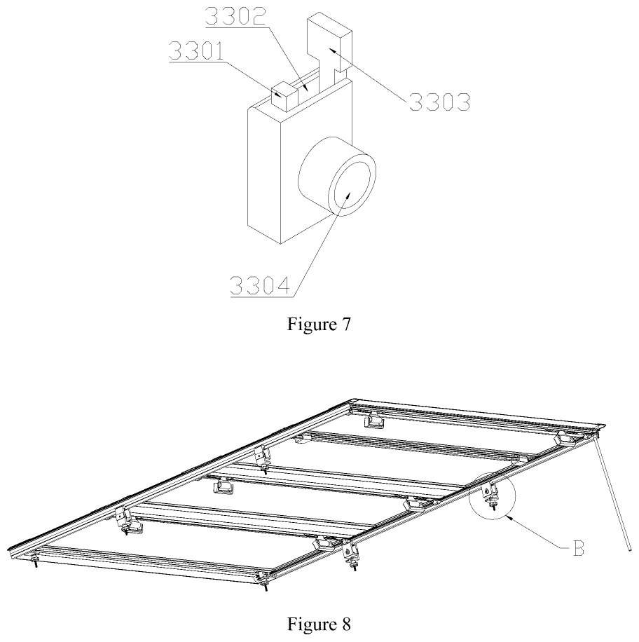

Based on Embodiments 3 or 4, as shown in FIGS. 5-7, the rail system 3 includes a head seal block 31, a first front rubber strip 32, a water guide block 33, an outlet pipe 34, a rail 35, and a second front rubber strip 36.

One end of the rail 35 is connected to the head seal block 31, while the other end of the rail 35 has a rail notch 3501. The rail notch 3501 is connected to the water guide block 33, which is further connected to the outlet pipe 34. Both the first front rubber strip 32 and the second front rubber strip 36 are attached to the rail 35.

The head seal block 31, the first front rubber strip 32, and the water guide block 33 form a U-shaped waterproof barrier, while the second front rubber strip 36 forms a second waterproof barrier.

The water guide block 33 is equipped with a limit protrusion 3301 and a water-blocking protrusion 3303. The limit protrusion 3301 aligns with the rail notch 3501 for positioning, and the water-blocking protrusion 3303 is used to restrict water flow.

The rail 35 is mounted on both sides of the truck bed and is used to connect the cover panel. The second front rubber strip 36 is installed on the rail 35. Rainwater is directed to drain toward the outside of the truck bed under the influence of the second front rubber strip 36, preventing water from entering the rail 35. The first front rubber strip 32 further separates the interior of the truck bed from the exterior. Any water that manages to seep in is blocked by the first front rubber strip 32 and directed into the U-shaped channel formed by the rail 35 and the first front rubber strip 32 the U-shaped channel is located above the groove of the rail 35. Since both ends of the rail 35 are equipped with a head seal block 31 and a water guide block 33, the head seal block 31 acts as a barrier, while the water guide block 33, when connected to the outlet pipe 34, facilitates drainage. The water inlet of the water guide block 33 is located at its upper end, allowing water to flow into the block under gravity and be expelled.

### Embodiment 6

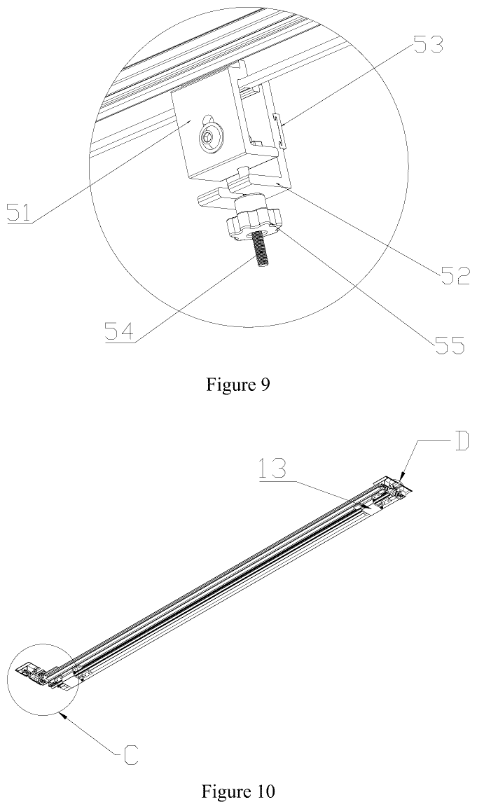

Based on Embodiment 5, as shown in FIGS. 8 and 9, the clip system 5 includes a left clip 51, a right clip 52, a threaded block 53, a T-bar 54, and a star nut 55. The left clip 51 and right clip 52 are used to clamp the truck bed and the rail 35. The left and right clips 51, 52 are connected by a screw, with one end of the screw attached to the threaded block 53, which is locked into the right clip 52. The T-bar 54 passes through both the left clip 51 and the right clip 52. One end of the T-bar 54 abuts the left clip 51, and the other end is connected to the star nut 55.

The left clip 51 extends into the rail groove, while the right clip 52 clamps the truck bed from the outside, securing the rail 35 to the vehicle body. The threaded block 53 is then attached to the right clip 52, locking into place. A screw is passed through the left clip 51 and threaded into the threaded block 53, achieving horizontal clamping between the left and right clips 51, 52 in one step. Finally, the T-bar 54 is connected to the star nut 55. By tightening the nut, the left and right clips 51, 52 are pulled together vertically, enabling multidirectional fastening of the clip system 5.

### Embodiment 7

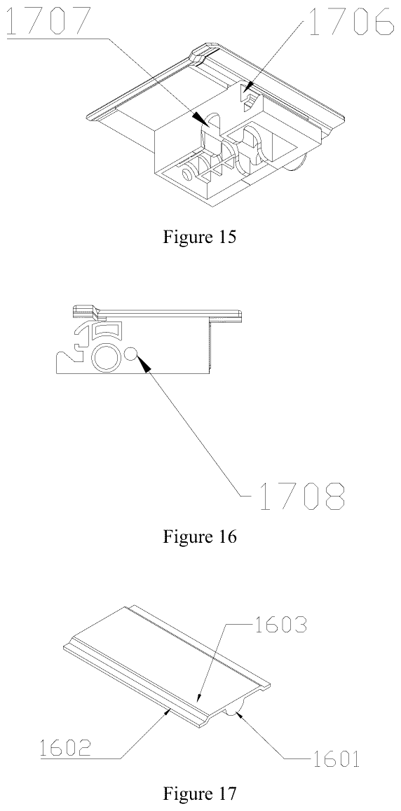

Based on Embodiment 6, as shown in FIGS. 14-17, the hinge rubber strips include a first hinge rubber strip 14 and a second hinge rubber strip 15. The first hinge 1 is connected to the first pivot rod 11 via the rubber strip, while the second hinge rubber strip 15 is connected to the second pivot rod 12. The first hinge rubber strip 14 features a first compression surface 1401, and the second hinge rubber strip 15 features a second compression surface 1501. The first hinge rubber strip 14 and the second hinge rubber strip 15 are positioned on either side of the compensating rubber strip 16. The first compression surface 1401 and the second compression surface 1501, together with the extrusion protrusion 1601, form pressurized surfaces.

Both the first joint 17 and the second joint 18 are equipped with a first adhesive surface 1701 and a second adhesive surface 1702. The compensating rubber strip 16 also has a first adhesive surface 1602 and a second adhesive surface 1603. The first adhesive surface 1602 and the second adhesive surface 1603 are respectively bonded to the first adhesive surface 1701 and the second adhesive surface 1702.

As the hinge system rotates, gaps may form between the pivot rods. To address this, hinge rubber strips are installed between the two pivot rods, providing waterproofing through mutual compression at the center. Additionally, compensating rubber strips 16 are added at the ends. The compressive interaction between the compensating rubber strips 16 and the hinge rubber strips enhances the waterproofing effect. Joints are connected at both ends of the pivot rods to integrate with the rail 35 structure. The joints are bonded to the compensating rubber strips 16, ensuring both connection stability and improved waterproofing.

The first joint 17 is also equipped with a profile cover 1705, a first screw hole 1704, a rubber strip insertion slot 1706, a screw arch 1707, and a second screw hole 1708. The profile cover 1705 is used to connect the panel, the joint protrusion 1703 is used to connect to the rail 35, and the rubber strip insertion slot 1706 is used to connect the hinge rubber strip. The screw arch 1707 and second screw hole 1708 are used for connection with the pivot rod.

The joint is connected to the pivot rod via screws, ensuring a stable connection and preventing water leakage. Additionally, the profile cover 1705 connects to the profiles at both ends of the panel. Finally, the first joint 17 connects to the hinge rubber strip through the rubber strip insertion slot 1706, allowing the hinge rubber strip to pass through the pivot rod and the joint, thereby enhancing overall integrity and sealing performance.

### Embodiment 8

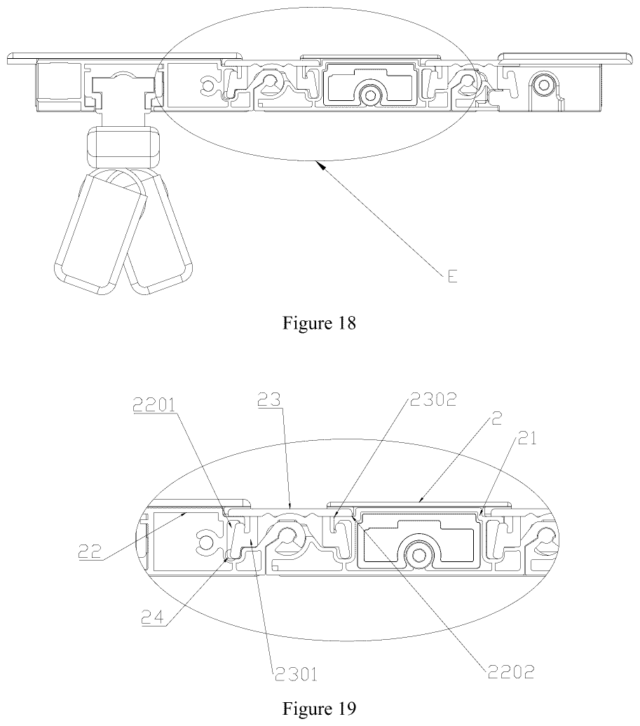

Based on Embodiment 7, as shown in FIGS. 18 and 19, the second hinge 2 includes a second hinge central shaft 21, side rods 22, a third hinge rubber strip 23, and side rod wires 24. The third hinge rubber strip 23 consists of a rubber strip insertion head 2301 and a rubber strip adhesive surface 2302. The side rod 22 features a side rod rubber strip insertion slot 2201 and a side rod adhesive surface 2202. The rubber strip insertion head 2301 connects to the side rod rubber strip insertion slot 2201, and the side rod wire 24 extends into the side rod rubber strip insertion slot 2201, compressing the rubber strip insertion head 2301. The rubber strip adhesive surface 2302 adheres to the side rod adhesive surface 2202.

The second hinge 2 has a different structure from the first hinge 1. In the second hinge 2, a central rod is used, with a side rod 22 positioned on each side to connect to the panel. A rotation center is established between the side rod 22 and the central rod, and the rotation center is equipped with a third hinge rubber strip 23 for waterproofing. The third hinge rubber strip 23 is clamped between the central rod and the connecting section. The side rod wire 24 is inserted into the side rod rubber strip insertion slot 2201, compressing the rubber strip insertion head 2301 to ensure fuller filling of the rubber strip, thereby enhancing the sealing performance.

This invention is not limited to the optional embodiments described above. Anyone inspired by this invention may derive other forms of products. Regardless of changes in shape or structure, any technical solution that falls within the scope defined by the claims of this invention is included within its protection scope.

What is claimed is:

1. A tonneau cover for pickup truck, comprising:
a rail system, a hinge system, a cover panel, and a clip system, wherein
the rail system is connected to a truck bed through the clip system,
the cover panel is connected to the rail system and comprises multiple panels, which are interconnected through the hinge system,
the hinge system comprises a first hinge and a second hinge, wherein the first hinge comprises a first pivot rod, a second pivot rod, a rotating hinge, hinge rubber strips, compensating rubber strips, a first joint, and a second joint, wherein
the first pivot rod and the second pivot rod are connected by the rotating hinge, both sides of the first and second pivot rods that are close to each other are equipped with hinge rubber strips,
the ends of the first pivot rod are connected to the first joint, and the ends of the second pivot rod are connected to the second joint,
the first joint and the second joint are connected by the compensating rubber strips, which are equipped with extrusion protrusions, wherein these extrusion protrusions are configured to compress and interact with the hinge rubber strips.

2. The tonneau cover according to claim 1, wherein the hinge system further comprises a third hinge, wherein the third hinge comprises a central axle for the third hinge, and the second hinge comprises a central axle for the second hinge, with the widths of the central axles of the second and third hinges being the same.

3. The tonneau cover according to claim 1, wherein the panel comprises a large panel, a medium panel, and a small panel, wherein
the large panel is equipped with a first slot and a second slot, the first slot has a first hook and a third hook connected at its ends, and the second slot comprises a second hook and a fourth hook connected at its ends,
the first hook, the second hook, the third hook, and the fourth hook are all configured to engage with the rail system.

4. The tonneau cover according to claim 1, wherein the panel comprises a large panel, a medium panel, and a small panel, wherein the large panel is equipped with a first slot, a second hook, a second slot, a fourth hook, and a locking tongue system,
wherein the large panel has a first slot and a second slot, with the first slot connected to the locking tongue system, and the ends of the second slot connected to the second hook and the fourth hook.

5. The tonneau cover according to claim 3, wherein the rail system comprises a head seal block, a first front rubber strip, a water guide block, an outlet pipe, a rail, and a second front rubber strip, wherein
one end of the rail is connected to the head seal block, and the other end of the rail features a rail notch, which is connected to the water guide block, the water guide block is connected to the outlet pipe, and both the first front rubber strip and the second front rubber strip are attached to the rail,
the head seal block, the first front rubber strip, and the water guide block form a U-shaped waterproof barrier, while the second front rubber strip forms a second waterproof barrier,
the water guide block is equipped with a limit protrusion and a water inlet with a water-blocking protrusion, wherein the limit protrusion aligns with the rail notch for positioning, and the water inlet allows water to be channeled from the rail into the water guide block, the water-blocking protrusion is configured to limit the flow of water.

6. The tonneau cover according to claim 1, wherein the clip system comprises a left clip, a right clip, a threaded block, a T-bar, and a star nut, wherein
the left clip and right clip are configured to clamp the truck bed and the rail, the left clip and right clip are connected by a screw, one end of which is connected to the threaded block, which is engaged with the right clip, the T-bar passes through both the left clip and the right clip, with one end of the T-bar abutting the left clip, and the other end connected to the star nut.

7. The tonneau cover according to claim 1, wherein the hinge rubber strips comprise a first hinge rubber strip and a second hinge rubber strip, wherein the first hinge rubber strip is connected to the first pivot rod, and the second hinge rubber strip is connected to the second pivot rod,
the first hinge rubber strip features a first extrusion surface, and the second hinge rubber strip features a second extrusion surface, the first hinge rubber and the second hinge rubber strips are respectively positioned on either side of the compensating rubber strip, with the first extrusion surface and the second extrusion surface forming pressing surfaces with the extrusion protrusion.

8. The tonneau cover according to claim 1, wherein both the first joint and the second joint are equipped with a first adhesive surface and a second adhesive surface, the compensating rubber strip comprises a first adhesive surface and a second adhesive surface, wherein the first adhesive surface and the second adhesive surface are respectively adhered to the first adhesive surface and the second adhesive surface.

9. The tonneau cover according to claim 1, wherein the first joint comprises a profile cover, a first screw hole, a rubber strip insertion slot, a screw arch, and a second screw hole, wherein the profile cover is configured to connect to the panel, the joint protrusion is configured to connect to the rail, the rubber strip insertion slot is configured for attaching hinge rubber strips, and the screw arch and the second screw hole are configured for connection to the pivot rod.

10. The tonneau cover according to claim 1, wherein the second hinge comprises a second hinge central shaft, a side rod, a third hinge rubber strip, and a side rod wire, wherein
the third hinge rubber strip consists of a rubber strip insertion head and a rubber strip adhesive surface, the side rod is equipped with a side rod rubber strip insertion slot and a side rod adhesive surface, the rubber strip insertion head is connected to the side rod rubber strip insertion slot, and the side rod wire extends into the side rod rubber strip insertion slot and compresses the rubber strip insertion head, with the rubber strip adhesive surface and side rod adhesive surface adhering the wire compression for waterproofing and adhesive waterproofing can be interchanged.
